(19) United States
(12) Patent Application Publication
(10) Pub. No.: US 2021/0330530 A1
(43) Pub. Date: Oct. 28, 2021

(54) LIFT FOR FALLEN PERSON AT HOME

(71) Applicants: Robert Platts, Ottawa (CA); Andrew Katz, Ottawa (CA); Rebecca Cooney, Ottawa (CA)

(72) Inventors: Robert Platts, Ottawa (CA); Andrew Katz, Ottawa (CA); Rebecca Cooney, Ottawa (CA)

(21) Appl. No.: 16/856,084

(22) Filed: Apr. 23, 2020

(51) Int. Cl. A61G 7/10; E06C 1/20; E06C 7/12

(52) U.S. Cl. CPC A61G 7/1011; A61G 7/1051; E06C 7/12; E06C 1/20; A61G 7/1015

(57) ABSTRACT

A household lift for fallen persons is devised in which a modified stepladder serves as the main lift structure while also serving as a stepladder storably foldable and usable within the house. A removable winch is set atop the stepladder, and it too can serve other purposes and can be of hand-cranked or electric powered design. The winch's lift cable is removably attached to preferably a prior-art sling type which first lays flat on the floor to facilitate moving the person onto it, and next pulls the person up into a secure sit-up position and then high enough to lower onto a wheelchair or other safe destination.

### TECHNICAL FIELD

The invention relates to providing a lift for fallen persons within their house, based on a stepladder designed for that while also storagable and usable as a household stepladder.

### BACKGROUND OF THE INVENTION

The risk of falls is rising fast with aging populations, boosted by the prevalence of vision and balance problems, muscle weakness and more. More than one in three people aged 65 and over falls each year (www.nia.nih.gov/health/prevent-falls-and-fractures). And younger people fall too, of course, especially where affected by circulatory problems, MS, Parkinsons, arthritis and other problems. Wheelchair-bound people may fall in transferring from chair to bed or vice versa. Falls may do little harm but often the fallen person (the “patient”) is unable to get back up. A helpmate can make a crucial difference for some—while risking injuring themselves—but the weaker or heavier patient usually needs more than one helper.

Hospitals and nursing homes often have very fine equipment to raise fallen patients and transfer them into a bed. Their designs generally parallel the construction industry's “tower crane” or “boom crane”, with the victim first rolled onto a flat sling-like lifter roped to the crane above. The rigs are not usable in a typical house or apartment, however, generally being too tall or wide or at least too costly.

Clever smaller rigs are available for households. Examples: stacked inflatable cushion lifts (David Garman, Wales, https://mangarhealth.com/store/product/patient-lifting/elk-lifting-cushion); miniature “fork lifts” (Van Oirschot, California, http://indeelift.com/); remarkable scissor-action lift (Lykkegard, Denmark, www.liftup.dk). But such household rigs also have drawbacks: interference with rolling the patient onto the lift; the need to sit the patient up first; difficulty in keeping the patient steady and safe during the lift; awkwardness in moving the patient off the rig and onto a chair or bed; reliance on sling designs which tend to force knees up toward chest, potato-sack fashion; and always, intrinsic costliness, raising the question of how many would invest so much in a single-purpose device which—one always hopes—will never be needed?

### SUMMARY OF THE INVENTION

The purpose of this invention is to provide an affordable household lift device (“lift”) wherewith a helper can raise a fallen person (“patient”) from the floor safely into a chair or wheelchair, the device serving also as a stepladder storably foldable and usable within the house. The stepladder structure is designed to accept and secure a winch under its top and provide adequate room between its rails to accommodate the patient, whereupon the helper can help the fallen patient roll onto a sling laid out on the floor, mount the winch on the stepladder, set the stepladder over the patient, connect the sling to the winch line, crank or power the winch to lift the slung patient to a sitting position within the stepladder, push a wheelchair or other chair under the patient and lower the patient into it. The winch line is then detached from the sling, which itself remains comfortably on the seat cushion under the patient, who can then get on with daily living or get moved into bed to rest or await further care if needed.

These and other features and advantages of the invention will become more apparent when the detailed description is studied in conjunction with the accompanying drawings, in which like elements are designated by like reference characters. What is described is our test-piece “ladder lift”—which was crucially tested two days after assembly: a 6′-4″, 250 lb patient was lifted from a serious fall by his spouse and nicely reseated in his wheelchair.

Terms: “Rail” has been somehow established to denote a stepladder leg. “Width” here refers to the distance between the two rails supporting the steps. “Front” here refers to that step side, “rear” the opposite side, and “side” the remaining aspect in which “spread” refers to the distance from front rail to rear rail directly behind, the maximum spread being the distance between the feet of the front rails from the feet of the rear rails. “Spreader” has been somehow established to denote spread-preventing ties that keep the feet of the rear rails from sliding farther away from those of the front rails.

### BRIEF DESCRIPTION OF THE DRAWINGS

FIG. 1 is a front elevational view of the invention in action.

FIG. 2 is a side elevational view of the invention, job done.

### DETAILED DESCRIPTION OF THE PREFERRED EMBODIMENTS

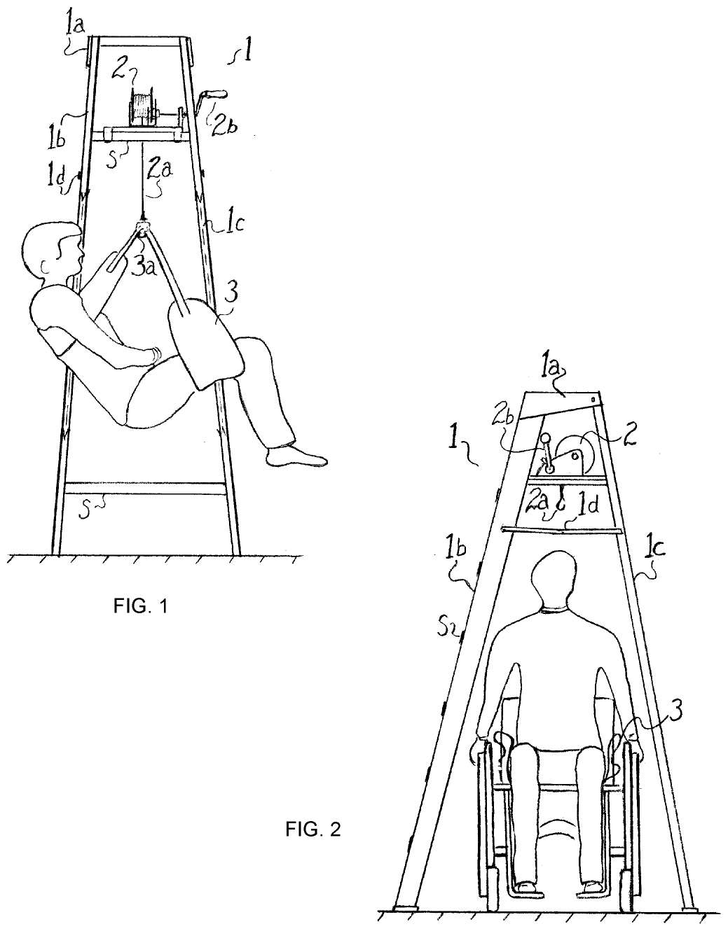

In FIG. 1, the patient has been raised slightly higher than a wheelchair seat, a helper having first maneuvered the fallen patient onto a sling 3 (a type that keeps a patient leaned back as shown rather than bundled vertically like a sack of potatoes), set and secured the winch 2 on the stepladder 1, shifted the prepared stepladder 1 over the patient on the floor and connected the winch line 2a to the sling 3. The base of the winch 2 has its front set on a step S and its rear set on a bar across the rear rails, secured (removably) with cleats and hook-and-loop bands in this case. (The bar, cleats and bands are not clearly visible. Of course there are alternative mounting methods for removably securing the winch, one being to have a hook on top of the winch engaging a loop or openings in the stepladder's top—also not shown). The winch handle 2b is on an extended shaft so that it clears the ladder's rails 1b and 1c, and can be operated by the helper standing in front of the steps S (or on a step). The front rails 1b and steps are cut away for clarity, better showing the patient and sling. The cutaway reveals portions of the rear rails 1c. While these are better shown in FIG. 2, the ends of the ladder's top-spreading gussets 1a and the ends of spread-restraining ties (“spreaders”) 1d can be seen here.

(While the illustrated winch 2 is manually operated, it could of course be an electric motor type, although that would add cost and considerably more weight.)

FIG. 2 shows the patient successfully lowered into the wheelchair, which the helper has wheeled in from behind the lifted patient. The sling 3 has been detached from the winch line 2a and remains under the patient as shown. The patient can now be helped to stand or wheel or be wheeled to a bed or other security, the sling 3 then free to be removed and put away. The winch 2 with cord 2a is removed and stored “on call” for such an emergency, while the stepladder 1 is folded and stored ready for general usage—or such emergency usage. The ladder design modifications are clear: to afford room for the lifted patient while fitting under house ceilings, a common 8 ft. high stepladder has been cut down to 6.5 ft. while its spread at the top has been maintained by rigidly attaching gussets 1a to the front rails 1b and hingedly attaching them the rear rails 1c. The spreaders 1d keep the feet of the rails from sliding apart under load (and high-friction feet help prevent that as well). The ladder still folds up compactly for storage.

It should be noted that the changes made to the usual stepladder design (to keep it short enough for household use but broad enough to accommodate the lifted patient) have shortened the distance of the spreaders 1d from the top, increasing “leverage” tension on the spreaders and bending force on the rails; some strengthening may be justified. And, back to FIG. 1, a further change to common stepladder design is to widen its stance on the floor—as shown or even a bit wider—for better side-to-side stability during a lift.

We claim:

1. An apparatus serving as both a lift for a fallen person at home and a household stepladder, comprising:
a stepladder structure of height well below ceiling height and providing adequate room between its front and rear rails to accommodate a patient lifted above chair height, the stepladder being foldable for compact storagability;
a winch mounted under the top of the stepladder;
a sling layable flat on floor beside the fallen patient to accept the patient being rolled onto it; whereupon the stepladder can be set over the patient, the cable of the winch lowered and attached to the sling, and the winch operated to lift sling and patient securely into a sitting position within the stepladder's rails and then to a height allowing a chair or wheelchair to be positioned under the patient.

2. The apparatus according to claim 1, wherein:
the tops of the front rails of the stepladder are rigidly gusseted to extend horizontally and fasten hingedly to the tops of the rear rails, holding the tops of the rear rails apart from the front rails in order to provide more room to accommodate the lifted patient while the stepladder remains short enough to operate indoors, and remains foldable for compact storage;
the winch is removably mounted so that it may be affixed on the stepladder only when needed to lift a fallen patient, leaving the stepladder significantly lighter when used just as a stepladder or being moved to the patient.
